(19) United States
(12) Patent Application Publication
(10) Pub. No.: US 2022/0414686 A1
(43) Pub. Date: Dec. 29, 2022

(54) Automated Testing of Forms

(71) Applicant: Klaviyo, Inc, Boston, MA (US)

(72) Inventors: Michael T. Lawson, Boston, MA (US); Ally Hangartner, Sarasota, FL (US); Maritza Ebling, Boston, MA (US); Vinicius Aurichio, San Paolo (BR)

(73) Assignee: Klaviyo, Inc, Boston, MA (US)

(21) Appl. No.: 17/527,761

(22) Filed: Nov. 16, 2021

Related U.S. Application Data
(60) Provisional application No. 63/214,778, filed on Jun. 24, 2021.

(51) Int. Cl. G06Q 30/02

(52) U.S. Cl. CPC G06Q 30/0201

(57) ABSTRACT

Apparatuses, methods, and systems for automated testing and selection of multiple templates of a form. One method includes generating, by a server, at least a first template of the form and a second template of the form, each of the first template and the second template having at least a different content or a different behavior, assigning, by the server, a respective group of site visitors to the first template of the form and the second template of the form, wherein the assigning is random, and determining automatically, by the server, whether the first template of the form has a statistical advantage over the second template of the form. For an embodiment, automatically determining the statistical advantage includes collecting test data, generating estimates of success rates for the first template and the second template.

### RELATED PATENT APPLICATIONS

This patent application claims priority to Provisional Patent Application Ser. No. 63/214,778 filed Jun. 24, 2021, which is herein incorporated by reference.

### FIELD OF THE DESCRIBED EMBODIMENTS

The described embodiments relate generally to intelligent electronic commerce. More particularly, the described embodiments relate to systems, methods and apparatuses for automated testing and selection of multiple templates of a form.

### BACKGROUND

Templates can be used for defining a form which can be provided to a website visitor. Different forms can have different levels of success when provided to the website visitor (customer).

It is desirable to have methods, apparatuses, and systems for automated testing and selection of multiple templates of a form.

### SUMMARY

An embodiment includes a computer-implemented method of automated testing of a form. The method includes generating, by a server, at least a first template of the form and a second template of the form, each of the first template and the second template having at least a different content or a different behavior, assigning, by the server, a respective group of site visitors to the first template of the form and the second template of the form, wherein the assigning is random, and determining automatically, by the server, whether the first template of the form has a statistical advantage over the second template of the form. For an embodiment, automatically determining the statistical advantage includes collecting test data from testing including qualification for views, views, and successes of the first template of the form and the second template of the form, generating estimates of a success rates for the first template and the second template including applying an analysis method to the collected test data to determine a win probability difference between a win probability for the first template and a win probability for the second template, and determine that the win probability difference is greater than a selected win threshold, determining that a precision of the estimates of the success rate is greater than a precision threshold, and determining that greater than a volume threshold of test data has been collected.

Another embodiment includes a system for automated testing and selection of multiple templates of a form. The system includes a site manager operating to manage a website, a plurality of site visitors operating to visit the website, and a server electronically connected to the site manager, the plurality of site visitors, and the website. The server operates to generate at least a first template of the form and a second template of the form, each of the first template and the second template having at least a different content or a different behavior, assign a respective group of site visitors to the first template of the form and the second template of the form, wherein the assigning is random, and determine automatically whether the first template of the form has a statistical advantage over the second template of the form. Determining the statistical advantage includes the server operating to collect test data from testing including qualification for views, views, and successes of the first template of the form and the second template of the form, generate estimates of a success rates for the first template and the second template including applying an analysis method to the collected test data to determine a win probability difference between a win probability for the first template and a win probability for the second template, and determine that the win probability difference is greater than a selected win threshold, determine that a precision of the estimates of the success rate is greater than a precision threshold, and determine that greater than a volume threshold of test data has been collected.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a system for automated testing and selection of a template of an electronic form, according to an embodiment.

FIG. 2 shows forms that require an input, according to an embodiment.

FIG. 3 is a flow chart that includes steps of a method for determining a statistical advantage of one template over another template, according to another embodiment.

FIG. 4 is a flow chart that includes steps of a method of determining a precision estimate of a success rate of a template, according to an embodiment.

FIG. 5 is a flow chart that includes steps of a method for assigning a respective group of site visitors to a first template of a form and a second template of the form, according to an embodiment.

FIG. 6 shows a system that further includes integrating information received from the testing with electronic marketing information, according to an embodiment.

FIG. 7 shows templates of a form each having different content or behavior, according to an embodiment.

FIG. 8 is a flow chart of steps of a method of automated testing and selection of multiple templates of a form, according to an embodiment.

FIG. 9 is a flow chart that includes steps of a method of testing variations of templates, according to an embodiment.

FIG. 10 is a flow chart that includes steps of a method of determining statistical significance of the different templates, according to an embodiment.

FIG. 11 and FIG. 12 include flow charts that includes steps of a method of selecting content and behavior of templates and integrating the different content or behavior with marketing activities, according to an embodiment.

### DETAILED DESCRIPTION

The embodiments described include methods, apparatuses, and systems for automated testing and selection of multiple templates of a form.

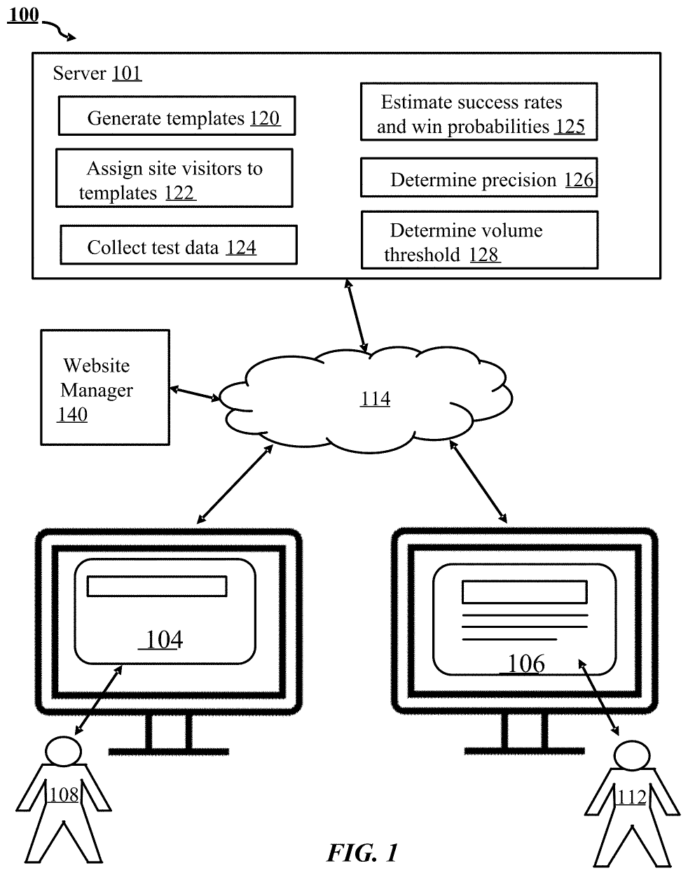

FIG. 1 shows a system 100 for automated testing and selection of a template of an electronic form, according to an embodiment. The system 100 includes a server 101. For an embodiment, the server 101 is electronically connected through a network 114 to electronic devices 104, 106 of site visitors 108, 112. For an embodiment, the server 101 operates to generate 120 at least a first template of the form and a second template of the form each having different content or behavior. Though described here as the generation of a first template and a second template, it is to be understood that the server 101 operates to generate N template that include the first template and a second template.

A website manager 140 operates and manages an ecommerce website. For an embodiment, the website manager 140 includes a server of a business that operates to directly control the ecommerce website. For an embodiment, the website manager 140 includes a combination of the business and a third party to operate to control the ecommerce website. For an embodiment, the website manager 140 is a customer of the operator of the server 101. For an embodiment, the website manager 140 is a combination of the customer of the operator of the server 101 and a third party (such as, a Shopify platform).

For an embodiment, each of the N templates includes a set of data objects that combine to represent a structure of a form. As described, the first and second templates of the N templates of the form each have a different content or behavior. Accordingly, the set of data objects of each of the first and second templates combine to represent a structure of forms having a different content and/or behavior. The structure of a form includes the content and the behavior. For an embodiment, the templates additional include information pertaining to testing of the form(s). The additional information can include, for example, a test name, a description of test (makes it easier to remember what is being tested), an ending date, and/or specific settings that correspond to statistical significance criteria. For an embodiment, the additional information pertaining to the testing combined with the data for the templates define a test.

For an embodiment, the server 101 operates to assign 122 a respective group of site visitors to the first template of the form and the second template of the form, wherein the assigning is random. For an embodiment, the site visitors are obtained by tracking information of visitors to the customer website managed by the website manager 140. For an embodiment, the site visitors include recent site visitors. For an embodiment, recent site visitors include site visitors that have visited the customer website within a predetermined time-period. For an embodiment, recent site visitors include a selected number of most recent site visitors. For an embodiment, recent site visitors) include site visitors who are qualified to view since a testing of templates has begun. For an embodiment, recent site visitors include site visitors since a specific event. For an embodiment, the specific event may include, for example, a large change in the settings of a template test.

For an embodiment, the server 101 further operates to determine automatically whether the first template of the form is statistically more advantageous than the second template of the form. For an embodiment, the server 101 operating to determine the statistical advantage includes collecting 124 test data from testing including qualification for views, views, and successes of the first template of the form and the second template of the form. Generally, a form with a statistical advantage is better at soliciting a desired response from a website visitor that is displayed the form.

### Qualification for Views

For at least some embodiments, the site visitor is shown (displayed on customer website) the form for at least one of multiple reasons, such as a geolocation of the site visitor, defined user behavior characteristics of the site visitor (for example, the site visitor has purchased from the site within the last 7 days), or a page URL (except amount of time spent on the page or amount of page scrolled or exit intent). A usage of the qualification for views may include a test between a template with a 5 second delay from moment of page load to moment that form appears and a template with a 10 second delay from moment of page load to moment that form appears, wherein there are no other differences between the templates. This usage of the qualification for views is a template (A/B) test which is used for qualification of views to make sure that the success rates being comparing are valid. For an embodiment, the delay may be selected by the website manager 140. For an embodiment, the success rate is defined as the number of successes divided by the number of qualified views. That is, for an embodiment, the number of people (site visitors) who are qualified to view the form is used as the denominator in the success rate equation to correctly account for different intent in the actual viewers.

### Views

For at least some embodiments, views are the number of site visitors (the customers of the website manager 140) to whom the form appears in the browser of the site visitor. That is, site visitor's geolocation, defined user behavior characteristic (for example, the site visitor has purchased from the site within the last 7 days), the page URL, and targeting characteristics such as any combination of time delay (amount of time from page load when form appears), scroll delay (amount of the page scrolled from the top until form appears), and exit intent behavior (moving the cursor outside of the window for the page) match the qualifications.

### Successes

For an embodiment, successes include the site visitor(s) carrying out a main action that a form is intended to elicit, such as, for example, filling in an email address or phone number and submitting that information, or clicking a button (such as, a mouse selection) to be navigated to a different page on the website.

For at least some embodiments, the server 101 further operates to generate estimates 125 of success rates for the first template and the second template including applying an analysis method to the collected test data to determine a win probability difference between a win probability for the first template and a win probability for the second template and determining that the win probability difference is greater than a selected win threshold.

For at least some embodiments, the server 101 further operates to determine that a precision 126 of the estimates of the success rate is greater than a precision threshold, and determines that greater than a volume threshold 128 of test data has been collected.

For an embodiment, the statistical advantage is declared for the first template when the selected win threshold, the precision threshold, and the volume threshold are all met. That is, the first template is determined to perform statistically better than the second template when the selected win threshold, the precision threshold, and the volume threshold are all met. The decision may be made by the website manager to favor the first template over the second template based on the statistical advantage demonstrated by the first template over the second template. For an embodiment, the server 101 automatically operates to favor the first template over the second template based on the statistical advantage demonstrated by the first template over the second template.

For at least some embodiments, the selected win threshold, the precision threshold, and the volume threshold are all preselected. For an embodiment, at least one of the selected win threshold, the precision threshold, and the volume threshold are preselected, and at least one other of the selected win threshold, the precision threshold, and the volume threshold is adaptively adjusted. For an embodiment, the selected win threshold, the precision threshold, and the volume threshold are all adaptively adjusted.

### Selected Win Threshold

For an embodiment, the selected win threshold is preselected based on best practices established over time. For an embodiment, the selected win threshold is adaptively selected based on input or feedback from the site visitors (customers of the website manager). For an embodiment, the selected thresholds are determined through prior simulation. For an embodiment, the selected win threshold is changed over time based on at least one of a plurality of factors. The factors can include preferences of the website operator (that is, directly selecting a threshold (if the website operator has a level of statistical knowledge) or the website operator choosing how “aggressive” they want to be to find a winner early or how “sure” they want to be in an outcome], a detected anomaly (that is, for example, an error in data collection), or pattern in collected data (that is, a very spiky (variations of greater than a threshold amount) visit volume pattern on a website that makes the website operator want to regularize to avoid extreme spikes having an effect that is too large). For an embodiment, the selected win threshold is adaptively adjusted based on one or more of these listed factors.

### Precision Threshold

For an embodiment, the precision threshold is preselected based on predicted or simulated false positive and false negative rates based on a number of qualification for views, views, and successes that are realistic, wherein realistic successes is based on historical data for a form on a website of the customer (site visitor). For an embodiment, the precision threshold is adaptively selected based on data from data of a particular website, or the data of websites that are similar (for example, a website that has similar observed patterns in business metrics and/or that sells similar products or is in a similar industry vertical a website with a similar amount of or pattern in site visitor traffic).

### Volume Threshold

For an embodiment, the volume threshold is preselected based on predicted or simulated false positive and false negative rates based on a number of qualification for views, views, and successes that are realistic, wherein realistic successes is based on historical data for a form on a website of the customer (site visitor). For an embodiment, the volume threshold is adaptively selected based on data from data of a particular website, or the data of web sites that are similar (for example, a website with a similar amount of site visitor traffic). For an embodiment, the volume threshold is adaptively selected based on data from data of a particular website, or the data of websites that are similar (for example, a website that has similar observed patterns in business metrics and/or that sells similar products or is in a similar industry vertical a website with a similar amount of or pattern in site visitor traffic).

For an embodiment, the generating of the estimates, checking the precision, and checking the volume threshold, appear to be performed simultaneously in real-time. That is, the operations are performed so that the performance appears simultaneous to a site visitor.

As previously described, for an embodiment, the server 101 further operates to generate estimates 125 of success rates for the first template and the second template including applying an analysis method to the collected test data to determine a win probability difference between a win probability for the first template and a win probability for the second template, and determine that the win probability difference is greater than a selected win threshold. For an embodiment, the analysis method includes generating a win probability, wherein the win probability represents a probability that a template variation currently leading the testing has a higher success rate than other variations after accounting for random chance. Example analysis methods include a Bayesian posterior probability or a frequentist p-value. For an embodiment, the random chance is accounted for by using at least one of these two methods.

At least some embodiments further include determining that a conversion rate is similar with conversion rates of forms, as opposed to other parts of the website. That is, for an embodiment, the form is displayed on the website. Portions of the website may solicit an input form the site visitor. However, for an embodiment, the applied analysis method is optimized for conversion rates similar with conversion rates of those seen in forms. For example, for a Bayesian prior that is constructed using historical forms data. For an embodiment, this is specific to the expected data setting for an individual form, using factors such as success rates on forms with similar behavior and design, success rates on forms from the same site or similar sites, or patterns of traffic on the page the form appears.

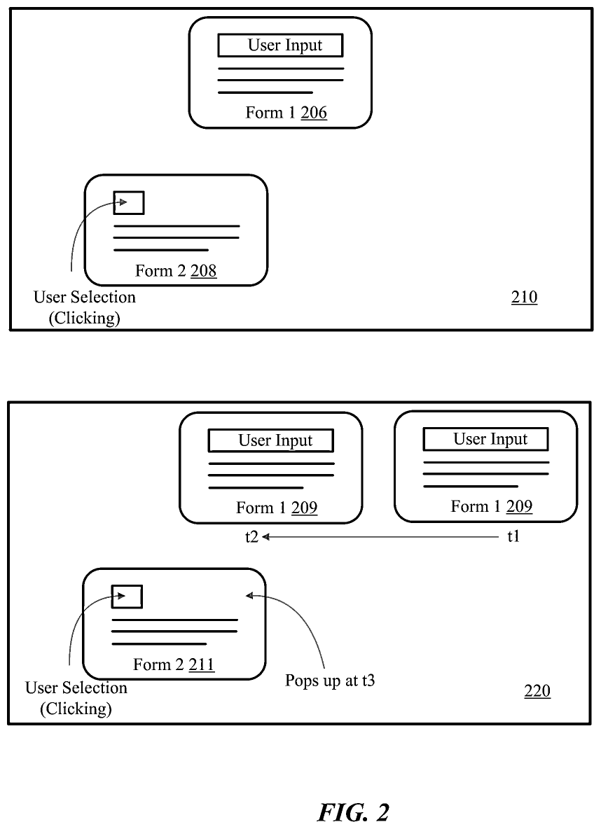

FIG. 2 shows forms that require an input, according to an embodiment. A first website display 210 includes a form 206 that requires an input from a user (site visitor), and a form 210 that requires a user input through, for example, a selection, such as, through a mouse click. A second website display 220 includes a form 209 that changes positions on the display between times t1 and t2, and a form 211 that “pops up” a time t3 after the webpage has been loaded. Clearly, other forms having different content and behavior can be utilized.

For an embodiment, the form includes a file configured to receive an input from a site visitor. For an embodiment, the required input includes at least one or more of the customer (site visitor) clicking to a different page, or the customer entering information. For an embodiment, the form is distinct from an underlying website which may include a dynamic and interactive page. For an embodiment, the forms of the templates are distinct from the underlying website because the forms appear visually and/or behaviorally distinct from the underlying page. For example, the behavior of the form may include the form popping up after the page is loaded or sliding out from the side after the rest of the page has been loaded.

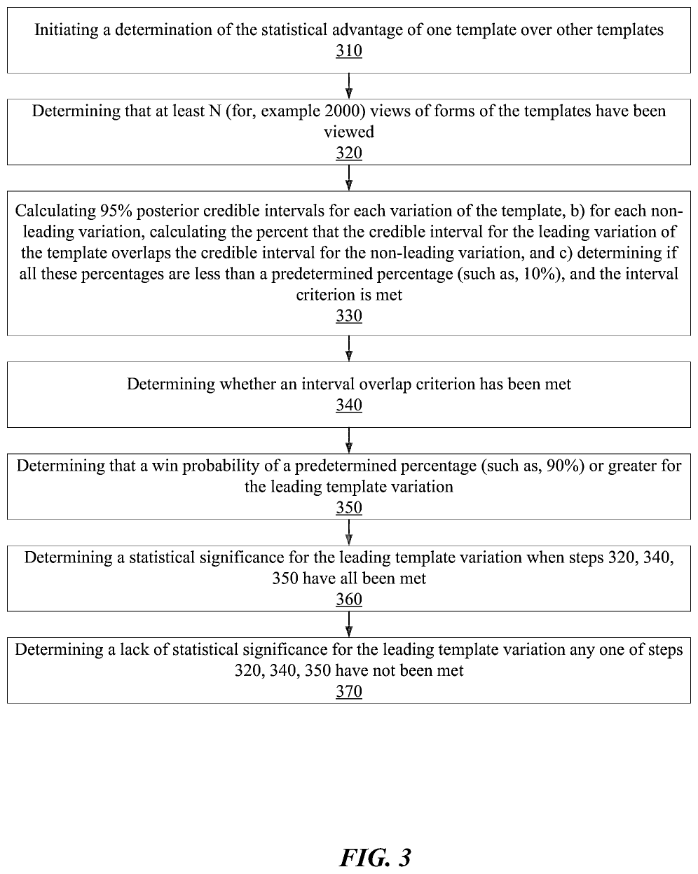

FIG. 3 is a flow chart that includes steps of a method for determining a statistical advantage of one template over another template, according to another embodiment.

As previously described, for an embodiment, the statistical advantage is declared for the first template when the selected win threshold, the precision threshold, and the volume threshold are all met. A first step 310 of the flow chart of FIG. 3 includes initiating a determination of the statistical advantage of one template over other templates. A second step 320 includes determining that at least N (for example, 2000) views of forms of the templates have been viewed. The step can be equated with the previously described volume threshold.

A third step 330 includes a) calculating 95% posterior credible intervals for each variation of the template representing the range of values that the success rate for this template is likely (in particular having a 95% level of confidence that the interval contains the true value of the success rate if infinite data is gathered) to take, and incorporating both the information contained in the Bayesian prior and the collected data), b) for each non-leading variation, calculating the percent that the credible interval for the leading variation of the template overlaps the credible interval for the non-leading variation (that is, intervals that have been defined above may overlap. That is, if one interval is (0, 10) and the second interval is (5, 15), then the percent overlap would be 50%), and c) determining if all these percentages are less than a predetermined percentage (such as, 10%), and the interval criterion is met. For an embodiment, step 330 is a necessary step to compute the precision threshold.

A fourth step 340 includes determining whether an interval overlap criterion has been met. For an embodiment, the interval overlap criterion is true (met) if the percent overlap calculated in step 330 is less than a pre-selected precision threshold.

A fifth step 350 includes determining that a win probability of a predetermined percentage (such as, 90%) or greater for the leading template variation. That is, the win probability threshold is satisfied.

A sixth step 360 includes determining a statistical significance for the leading template variation when steps 320, 340, 350 have all been met.

A seventh step 370 includes determining a lack of statistical significance for the leading template variation any one of steps 320, 340, 350 have not been met.

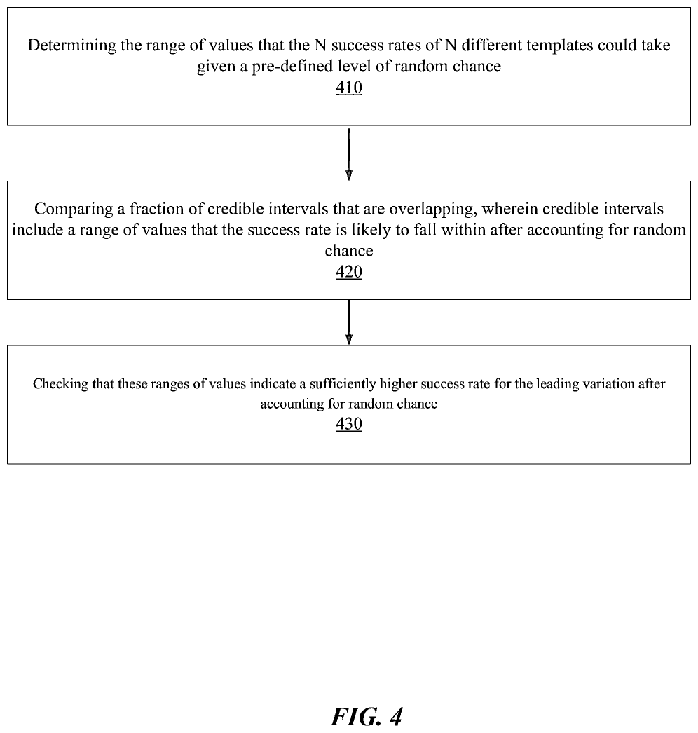

FIG. 4 is a flow chart that includes steps of a method of determining a precision estimate of a success rate of a template, according to an embodiment.

As previously described, at least some embodiments include checking that the precision of the estimates of the success rate is greater than a precision threshold. For an embodiment, checking that the precision of the estimates of the success rate is greater than a precision threshold includes 410 determining the range of values that the N success rates of N different templates could take given a pre-defined level of random chance,

For an embodiment, this includes 420 comparing a fraction of credible intervals that are overlapping, wherein credible intervals include a range of values that the success rate is likely to fall within after accounting for random chance. and 430 checking that these ranges of values indicate a sufficiently higher success rate for the leading variation after accounting for random chance. That is, step 430 includes determining whether the overlap fraction is small (below a certain threshold)

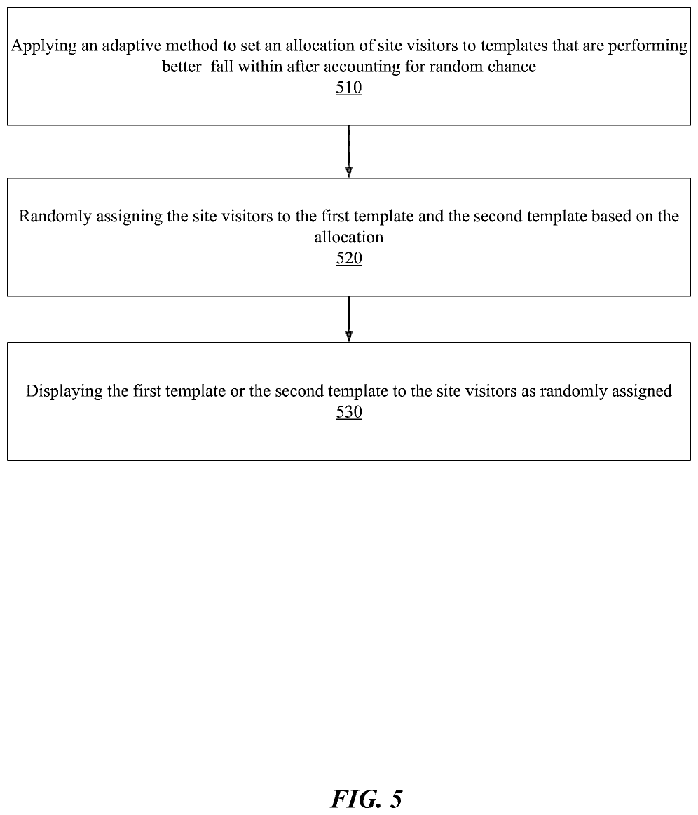

FIG. 5 is a flow chart that includes steps of a method for assigning a respective group of site visitors to a first template of a form and a second template of the form, according to an embodiment.

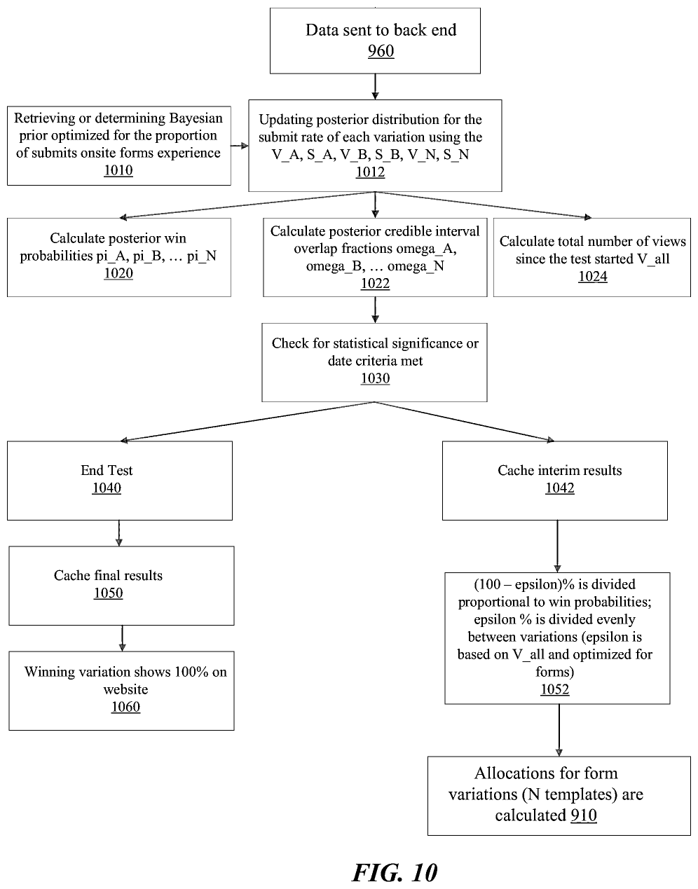

For an embodiment, assigning a respective group of the site visitors to the first template of the form and the second template of the form, wherein the assigning is random, includes 510 applying an adaptive method to set an allocation of site visitors to templates that are performing better (wherein better means a better success rate), 520 randomly assigning the site visitors to the first template and the second template based on the allocation, and 530 displaying the first template or the second template to the site visitors as randomly assigned. For an embodiment, the adaptive method includes multi-armed bandit optimization (MABO). For an embodiment, the adaptive method includes a method using an approach of an adaptive clinical trial design where the allocation changes at a small number of pre-set times. For an embodiment, the assignment includes a weighted assignment (visitor allocation percentage). For an embodiment, the weighting represents a deviation from an even split between variations of the template being tested. For example, weights could be computed based on the current success rates of the templates in the test. Templates being more successful could have a weighting of the visitor allocation that is adaptively increased. Step 1052 of FIG. 10 includes an example of this.

For an embodiment, the assignment of each of the site visitors is included within information attached to a browser of the site visitor, wherein the information allows actions by the site visitor to be tracked. Further, at least some embodiments further include determining a site visitor is eligible for the form based on whether the information attached to the browser of the site visitor indicates the site visitor has been assigned to the first template of the form and the second template of the form, and maintaining the assignment of the site visitor based on the information attached to the browser of the site visitor.

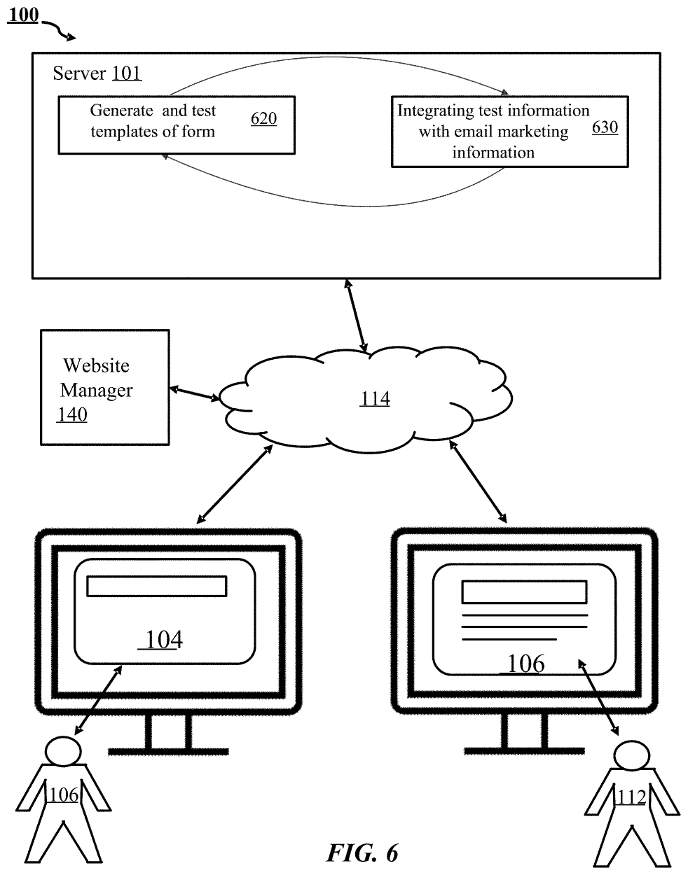

FIG. 6 shows a system that further includes integrating information received from the testing with electronic marketing information, according to an embodiment.

For an embodiment, integrating the electronic marketing information includes using electronic marketing information to qualify the site visitors. That is, for an embodiment, the electronic marketing information is used to target particular site visitors. For example, for an embodiment, templates are targeted to site visitors that have taken certain actions which have been tracked. That is, the templates in a particular test are only shown to site visitors who have clicked a specific email. This relates closely to the previously described qualification for views, and it is one potential reason for qualifying views of the site visitors.

For an embodiment, content in the template(s) is dynamically updated based on actions or characteristics of the user. For example, different images of forms of the templates are displayed to the site visitors based on the last product that the site visitor browsed.

For an embodiment, at least some of the test information determined during testing of the templates is used for influencing marketing information. For example, different coupons may be included with different tested templates to send emails with different discounts.

For an embodiment, integrating electronic marketing information includes ensuring that participants (website visitors) in the test have all taken actions pertaining to other marketing actions. For example, the actions taken, can include opening or clicking an email within the last X (such as, 7) days. For an embodiment, marketing information is used to qualify participant (site visitors).

For an embodiment, integrating electronic marketing information includes ensuring that different discount offers are present in different templates in the test. For example, this can include a 10% off discount for some templates versus free shipping for other templates that are delivered to the correct test participants though automated emails.

For an embodiment, integrating electronic marketing information includes counting the number of test participants who viewed one template in the test and carried out another action. For example, this can include counting the number of test participants that have purchased a product within the last next Y (for example 7) days.

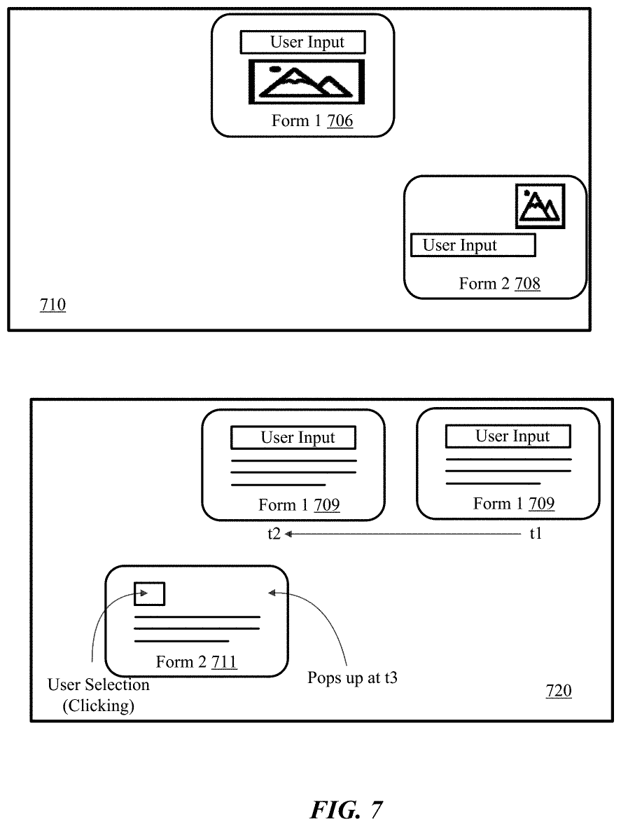

FIG. 7 shows templates of a form each having different content or behavior, according to an embodiment.

For an embodiment, the different content of the first template and the second template includes at least visual representations of the form, including at least one of a size, a text, a layout, a design, colors, or images of the form. A first display 710 of the website includes examples of forms 706, 708 that have different layouts.

For an embodiment, the different behavior of the first template and the second template includes presenting the form in different ways to different website visitors. For an embodiment, this includes presenting the form in different colors. For an embodiment, this includes presenting the forms to the website visitors for different amounts of time. For an embodiment, this includes presenting the form over different portions (for example, ⅓ of the screen or different) of the website visitor's screen. For an embodiment, this includes at least a time or scroll delay before the form appears, an exit intent or lack thereof, a portion of a screen that the form appears on, or an appearance method (for example, the form pops up or slide out slides out onto the screen). A second display 720 of the website includes a form 709 that moves from a first position on the display at time t1 to a second position on the display at time t2, and a form 711 that pops up on the display a period of time t3 after the webpage has been loaded.

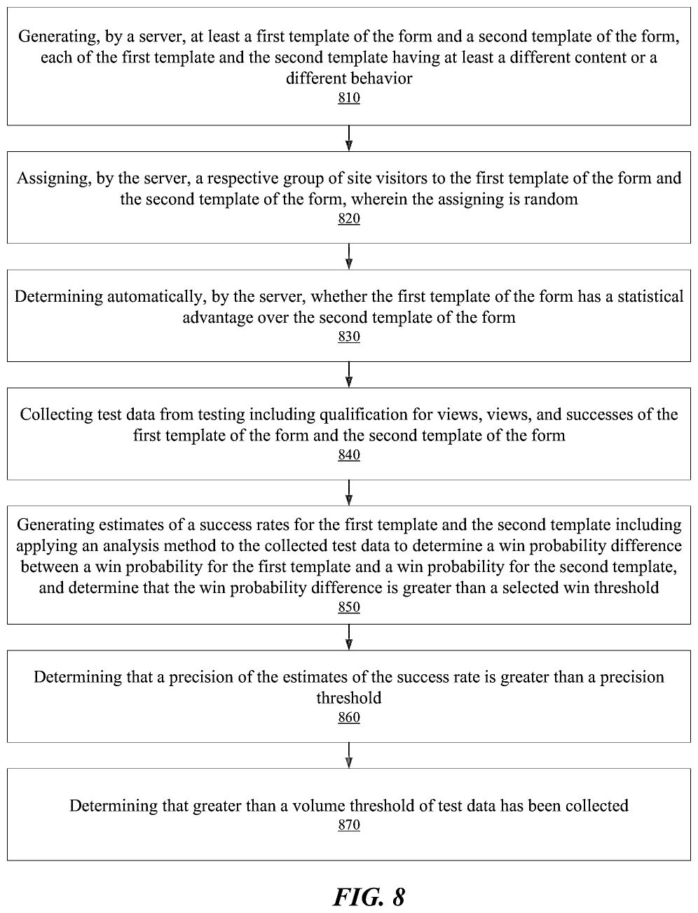

FIG. 8 is a flow chart of steps of a method of automated testing and selection of multiple templates of a form, according to an embodiment. A first step 810 includes generating, by a server, at least a first template of the form and a second template of the form, each of the first template and the second template having at least a different content or a different behavior. For an embodiment, the form includes a file configured to receive an input from a site visitor.

As previously described, the first and second templates of N templates of the form each have a different content or behavior. Accordingly, the set of data objects of each of the first and second templates combine to represent a structure of forms having a different content and/or behavior. The structure of a form includes the content and the behavior. For an embodiment, the templates additional include information pertaining to testing of the form(s). The additional information can include, for example, a test name, a description of test (makes it easier to remember what is being tested), an ending date, and/or specific settings that correspond to statistical significance criteria. For an embodiment, the additional information pertaining to the testing combined with the data for the templates define a test.

For an embodiment, the templates are used to integrate the process of testing the forms created by the templates into the practical application of controlling the content and behavior of the resulting forms on a display of a website visitor. As shown in FIG. 7, the content of the forms of the different template displayed on the display of the website visitor is different, or the behaviors of the forms of the different templates displayed on the display of the website visitor is different is different. The different content and/or behavior is integral and improves on testing of different forms.

A second step 820 includes assigning, by the server, a respective group of site visitors to the first template of the form and the second template of the form, wherein the assigning is random. A third step 830 includes determining automatically, by the server, whether the first template of the form has a statistical advantage over the second template of the form, which includes a fourth step 840 of collecting test data from testing including qualification for views, views, and successes of the first template of the form and the second template of the form, a fifth step 850 of generating estimates of a success rates for the first template and the second template including applying an analysis method to the collected test data to determine a win probability difference between a win probability for the first template and a win probability for the second template, and determine that the win probability difference is greater than a selected win threshold, a sixth step 860 of determining that a precision of the estimates of the success rate is greater than a precision threshold, and a seventh step 870 of determining that greater than a volume threshold of test data has been collected.

An embodiment includes displaying the form of the first template on the website when the first template of the form is determined to have a statistical advantage over the second template of the form. That is, for an embodiment, when the first template is determined to have a statistical advantage over the second template, the first template is identified as the winning template. As depicted at step 1060 of FIG. 10, when the winning template is displayed on the website with a 100% allocation. The selection of the winning template based on the success rates of the templates integrates the process of template selection into the practical application of displaying the most efficient and effective forms on the website, thereby providing improvements in the computing process of displaying forms.

For an embodiment, the statistical advantage is declared for the first template when the selected win threshold, the precision threshold, and the volume threshold are all met. For an embodiment, the generating of the estimates, determining the precision, and determining the volume threshold, are performed simultaneously.

For an embodiment, the analysis method includes generating a win probability, wherein the win probability represents a probability that a template variation currently leading the testing has a higher success rate than other variations after accounting for random chance. An embodiment includes determining that a conversion rate is similar to conversion rates of forms, as opposed to other parts of the website. As previously described, for an embodiment, the form is displayed on the website. Portions of the website may solicit an input form the site visitor. However, for an embodiment, the applied analysis method is optimized for conversion rates similar with conversion rates of those seen in forms. For example, for a Bayesian prior that is constructed using historical forms data. For an embodiment, this is specific to the expected data setting for an individual form, using factors such as success rates on forms with similar behavior and design, success rates on forms from the same site or similar sites, or patterns of traffic on the page the form appears.

For an embodiment, determining that the precision of the estimates of the success rate is greater than a precision threshold includes comparing a fraction of credible intervals that are overlapping, wherein credible intervals include a range of values that the success rate is likely to fall within after accounting for random chance. As previously described, a third step 330 of FIG. 3 includes a) calculating 95% posterior credible intervals for each variation of the template representing the range of values that the success rate for this template is likely (in particular having a 95% level of confidence that the interval contains the true value of the success rate if infinite data is gathered) to take, and incorporating both the information contained in the Bayesian prior and the collected data), b) for each non-leading variation, calculating the percent that the credible interval for the leading variation of the template overlaps the credible interval for the non-leading variation (that is, intervals that have been defined above may overlap. That is, if one interval is (0, 10) and the second interval is (5, 15), then the percent overlap would be 50%), and c) determining if all these percentages are less than a predetermined percentage (such as, 10%), and the interval criterion is met. For an embodiment, step 330 is a necessary step to compute the precision threshold.

For an embodiment, assigning a respective group of the site visitors to the first template of the form and the second template of the form, wherein the assigning is random, includes applying an adaptive method to set an allocation of site visitors to templates that are performing better, randomly assigning the site visitors to the first template and the second template based on the allocation, and displaying the first template or the second template to the site visitors as randomly assigned. For an embodiment, the assignment of each of the site visitors is included within information attached to a browser of the site visitor, wherein the information allows actions by the site visitor to be tracked. At least some embodiments further include determining a site visitor is eligible for the form based on whether the information attached to the browser of the site visitor indicates the site visitor has been assigned to the first template of the form and the second template of the form, and maintaining the assignment of the site visitor based on the information attached to the browser of the site visitor.

At least some embodiments further include integrating information received from the testing with electronic marketing information. For an embodiment, the electronic marketing information includes one or more of site visitor actions, discount offers, and product purchases. For an embodiment, integrating information received from the testing with electronic marketing information comprises using electronic marketing information to qualify the site visitors for the testing, includes ensuring that site visitors in the testing have all taken actions pertaining to other marketing actions. For an embodiment, integrating information received from the testing with electronic marketing information comprises dynamically updating content in the templates based on actions or characteristics of the user within the electronic marketing information. For an embodiment, integrating information received from the testing with electronic marketing information includes at least some of the test information determined during testing of the templates being used for influencing marketing information.

As previously described and shown in FIGS. 2 and 7, for an embodiment, the different content of the first template and the second template includes at least visual representations of the form, including at least one of a size, a text, a layout, a design, colors, or images of the form. Further, for an embodiment, the different behavior of the first template and the second template includes at least a time or scroll delay before the form appears, an exit intent or lack thereof, a portion of a screen that the form appears on, or an appearance method.

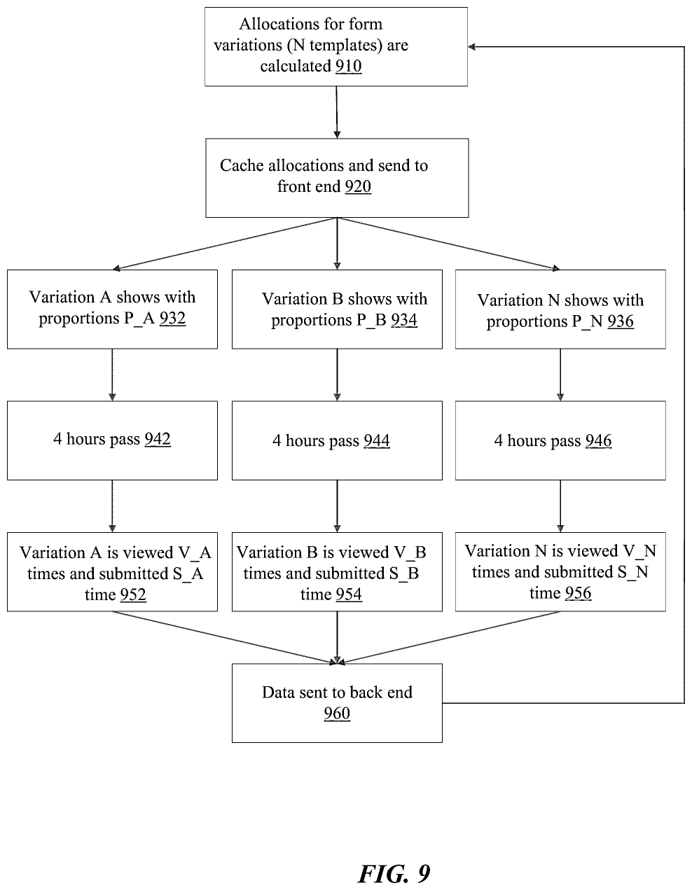

FIG. 9 is a flow chart that includes steps of a method of testing variations of templates, according to an embodiment. A first step 910 includes calculating allocations for form variations (N templates). For an embodiment, this includes assigning, by the server, a respective group of site visitors to the first template of the form and the second template of the form, wherein the assigning is random. A second step 920 includes caching the allocations and sending the allocations to a front end (for an embodiment, the front end is the portion of the server 101 that is responsible for responding to requests that the web site of the website manager makes). Third steps 932, 934, 936 include variation A showing with proportions P_A, variation B shows with proportions P_B, and variation N showing with proportions P_N. Fourth steps 942, 944, 946 include each of the variations A, B, N being utilized for a predetermined period of time, such as, 4 hours. Fifth steps 952, 954, 956 provides the test results, and include forms of each of the templates A, B, N being viewed V_A, V_B, V_N times, and inputs to the forms of each of the templates A, B, N being submitted S_A, S_B, S_N times. The test data can then be sent 960 back to the backend server (for an embodiment, the backend server is the portion of the server 101 that a website manager or their website does not directly interact with, but that stores and computes data). For an embodiment, after completion of step 960, a wait period (for example, a 4 hour wait) is performed, then step 910 is performed, and steps 910-960 are cycled through many times in the course of a test before the test ends.

FIG. 10 is a flow chart that includes steps of a method of determining statistical significance of the different templates, according to an embodiment. For an embodiment, the method of this flow chart receives the test data sent 960 back to the backend server of 960 of the flow chart of FIG. 9. A set of first steps includes 1010 retrieving or determining, for example, Bayesian prior optimized for the proportion of submits onsite forms experience, 1012 updating posterior distribution for the submit rate of each variation using the V_A, S_A, V_B, S_B, V_N, S_N generated by the steps of FIG. 9. A set of second steps includes 1020 calculating posterior win probabilities pi_A, pi_B, pi_N, 1022 calculating posterior credible interval overlap fractions omega_A, omega_B, omega_N, and 1024 calculating a total number of views (V_all) since the test started. A third step 1030 includes checking whether a statistical significance or date criteria has been met. For an embodiment, the data criteria includes specifying that a pre-specified time has passed. For example, the date criteria may include “end the test before Black Friday”.

For an embodiment, step 960 includes test data. For an embodiment, the test data includes the V_A, S_A, V_B, S_B, V_N, S_N.

For an embodiment, the flow chart of FIG. 10 is an implementation of step 510 of FIG. 5 for an adaptive method to set the allocation of site visitors to each template in the test. For an embodiment, the flow chart of FIG. 10 receives the test data, which for an embodiment includes V_A, V_B, . . . V_N, and the number of views or qualifications for views. For an embodiment, which of the number of views or qualifications for views that is included is dependent on which is used as the denominator for determining the success rate (for this particular test). That is, the success rate can be determined by either the number of successes divided by the number of qualified views or by the number of successes divided by the number of views. For an embodiment, which is used for determining the success rate is know or set when the test starts, and then does not change during the test.

For an embodiment, the test data is received for each of the templates since the test started, and S_A, S_B, . . . S_N, the number of successes for each template since the test started. For an embodiment, the test data is sent 960 to the portion of the server 101 that is responsible for computing values and storing data, but that is kept at a level of separation from the network 114.

For an embodiment, the test data is used in conjunction with 1010 Bayesian priors that are optimized to perform with test data in ranges that are typical for the proportion of submits that onsite forms experience. For an embodiment, the test data and the Bayesian priors are used at 1012 to update the posterior distribution for the submit rate for each template, which represents the current belief in which values the submit rate is likely to take after accounting for random chance, prior belief, and the test data collected so far. The use of a Bayesian posterior distribution is an example of an analysis method 850.

For an embodiment, the set of steps 1020, 1022, 1024 are carried out in parallel, or simultaneously. For an embodiment, the collection of updated posterior distributions computed in 1012 are used 1020 to compute posterior win probabilities pi_A, pi_B, . . . pi_N for each template, which represent the probability that the template A, B, . . . N has the highest submit rate of all the templates. The collection of updated posterior distributions computed in 1012 are also used to generate posterior credible intervals, which represent the highest-likelihood values that the submit rate for each template is likely to take, after accounting for random chance, prior belief, and the data collected in the test. For an embodiment, the leading template's posterior credible interval is compared 1024 to the other templates' posterior credible intervals; the overlap fraction omega_A, omega_B, . . . omega_N is calculated as the percent of the width of the smaller interval that also lies inside the other interval. For example, two non-overlapping intervals would have an interval overlap fraction of 0%, while the intervals [0.05, 0.15] and [0.10, 0.20] would have an interval overlap fraction of 50%. Finally, for an embodiment, the test data is used 1024 to determine the minimum number of views or qualification for views among all the templates in the test.

For an embodiment, the values calculated in 1020, 1022, and 1024 are used 1030 to determine whether a statistical significance criterion has been met. For an embodiment, this includes checking three separate criteria, all of which must be met for statistical significance to be declared. The win probability for the currently leading variation 1022 must be above an adaptive threshold; this is analogous to the win probability threshold 350. The largest of the interval overlap fractions 1022 must be smaller than an adaptive threshold; this is analogous to the precision threshold 340. The minimum number of views across all templates 1024 must be above an adaptive threshold; this is analogous to the volume threshold 320. If all these criteria are met, then statistical significance is achieved and the test is determined to be ready to stop. Additionally, even if statistical significance is not met, 1030 includes checking if a date criterion has been satisfied. A date criterion is satisfied if an adaptive date threshold has passed—for instance, if the website manager 140 specifies that a test must end by 2021-11-26. If the date criterion is met, then regardless of statistical significance, the test is determined to be ready to stop.

For an embodiment, if the test was determined to be ready to stop in 1030, it ends 1040. The final results are cached 1050 so that the final results can be sent to the server 101 at a time that is convenient for the server's activity. The winning template will show 1060 on the website with a 100% allocation.

For an embodiment, if the test was determined not to be ready to stop in 1030, then it continues. Interim results are cached 1042 so that the interim results can be sent to the server 101. The updated data are used to compute 1052 the new allocations that each template should show with on the website. In this embodiment, that process takes the form of dividing multiplying (100—epsilon) % by the posterior win probabilities for each template 1020, then dividing the remaining epsilon % evenly across all variations. For an embodiment, epsilon is an adaptive parameter that depends on the test data. For an embodiment, the allocations for each template are now computed 910, and as described in FIG. 9, they are used to control the proportion of the time that each form actually shows on the website.

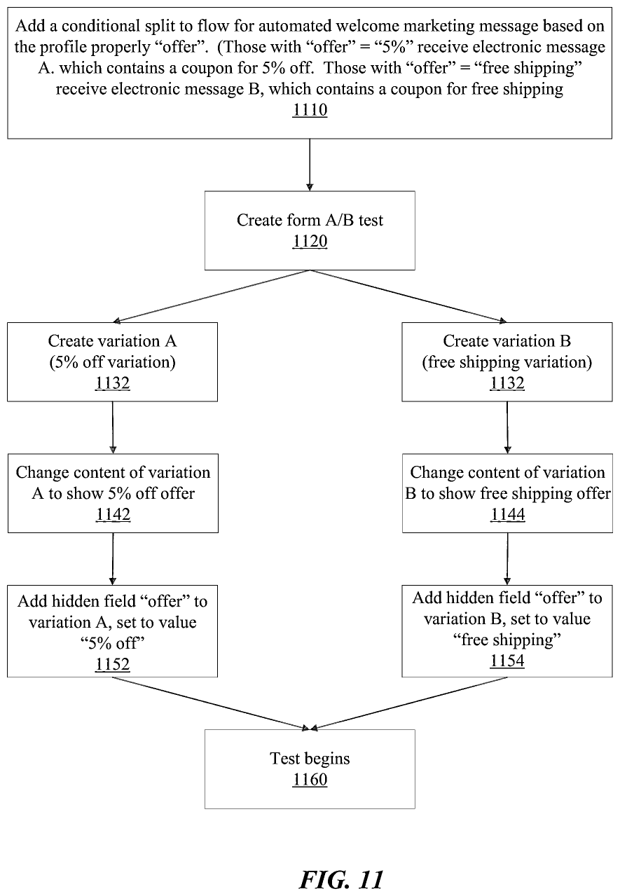

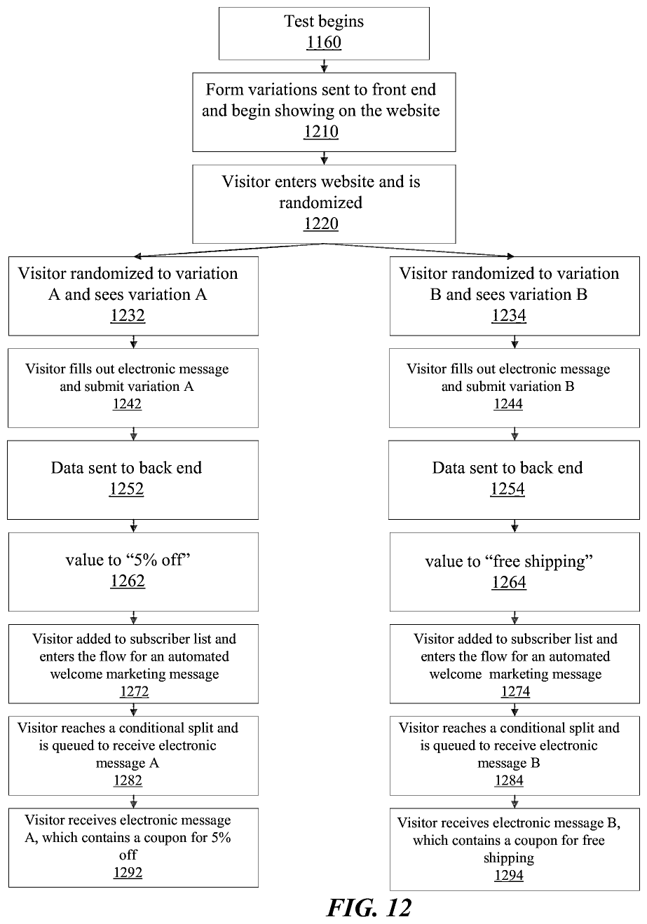

FIG. 11 and FIG. 12 include flow charts that includes steps of a method of selecting content and behavior of templates and integrating the different content or behavior with marketing activities, according to an embodiment. While generally described as electronic marketing messages, it is to be understood the electronic marketing messages include any type of marketing message, and can include emails, and SMS ( ) or a mobile push message.

A first step 1110 includes, for example, adding a conditional split to flow for an automated welcome marketing message based on the profile properly “offer”. For example, website visitors with an offer of 5% of receive an electronic message A (first template) which contains a coupon for 5% off, and website visitors with an offer of free shipping receive an electronic message (second template) which includes a coupon for free shipping.

A second step 1120 includes creating a form A/B test (wherein a form A and form B are two of the N possible created forms) that tests the first and second templates. A set of third steps include 1132 creating template variation A (5% off variation) and 1134 creating template variation B (free shipping). A set of fourth steps include 1142 changing content of variation of template A to show 5% off offer, and 1144 changing content variation B to show free shipping order. A set of fifth step include 1152 adding a hidden field “offer” to variation A set to value “5% off”, and 1154 adding a hidden field “offer” to variation B set to “free shipping”.

For an embodiment, the process of creating templates of steps 1132 and 1134 are generated 120 by the server 101, as are described more fully in FIG. 12.

For an embodiment, the hidden field includes additional data that is invisible to the site visitor, but that is stored with the data that the server 101 collects when test data is collected 124. This makes the hidden field distinct from a field that a user fills in, such as their email address or phone number.

A sixth step 1160 includes beginning or initiating the test.

FIG. 12 is a flow chart includes steps of a method of incorporating data from the test in marketing activities, according to an embodiment. A first step 1210 includes sending the form A, B variations of the first and second templates to a front end (of, for example, the server 101) and begin showing the form variations on the website. For an embodiment, the first step 1210 includes generating 120 the A and B templates (or any other number) of the form and sending the templates to the network 114 to be displayed on the website.

A second step 1220 includes site visitors entering the website and being randomly assigned.

A set of third steps include 1232 visitors that have been randomized to variation A seeing (having displayed) the variation A, and 1234 visitors that have been randomized to variation B seeing (having displayed) the variation B. For example, if a site visitor (such as, site visitor 108 of FIG. 1) is randomized to template A, that site visitor will see 104 the content and behavior of template A on the web site, including the “5% off” offer. However, another site visitor (such as, site visitor 112) who is randomized to template B will see 106 the content and behavior of template B on the website, including the “free shipping” offer.

A set of fourth steps include 1242 visitors that have been randomized to variation A filling out the electronic message and submitting the variation A, and 1244 visitors that have been randomized to variation B filling out the electronic message and submitting the variation B.

A set of fifth steps 1252, 1254 include collected data being sent to the backend server. For an embodiment, the data is sent from the network 114 to the server 101 and test data is collected 124 and stored, including the hidden fields set up in steps 1152 and 1154.

A set of sixth steps include 1262 setting the value to “5% off”, and 1264 setting the value to “free shipping”. For an embodiment, the hidden field is associated with the correct site visitor. As previously described, for an embodiment, site visitor 108 would have the hidden field “5% off” associated with them, and site visitor 112 would have the hidden field “free shipping” associated with them.

A set of seventh steps 1272, 1274 include adding the visitor to the subscriber list and entering the flow for an automated welcome electronic marketing message.

A set of eighth steps include 1282 the visitor (such as, site visitor 108) reaching a conditional split and being queued to receive electronic message A, and 1284 the visitor (such as, site visitor 112) reaching a conditional split and being queued to receive electronic message B.

A set of ninth steps include 1292 the visitor (such as, site visitor 108) receiving electronic message A which contains a coupon for 5% off, and 1294 the visitor (such as, site visitor 112) receiving electronic message B which contains a coupon for free shipping.

Although specific embodiments have been described and illustrated, the embodiments are not to be limited to the specific forms or arrangements of parts so described and illustrated. The described embodiments are to only be limited by the claims.

What is claimed:

1. A computer-implemented method for testing of a form, comprising:
generating, by a server, at least a first template of the form and a second template of the form, each of the first template and the second template having at least a different content or a different behavior;
assigning, by the server, a respective group of site visitors of a website to the first template of the form and the second template of the form, wherein the assigning is random;
determining automatically, by the server, whether the first template of the form has a statistical advantage over the second template of the form through testing, comprising;
collecting test data from testing including qualification for views, views, and successes of the first template of the form and the second template of the form;
generating estimates of a success rates for the first template and the second template including applying an analysis method to the collected test data to determine a win probability difference between a win probability for the first template and a win probability for the second template, and determine that the win probability difference is greater than a selected win threshold;
determining that a precision of the estimates of the success rate is greater than a precision threshold;
determining that greater than a volume threshold of test data has been collected; and
displaying the form of the first template on the website when the first template of the form is determined to have the statistical advantage over the second template of the form.

2. The computer-implemented method of claim 1, wherein the form includes a file configured to receive an input from a site visitor.

3. The computer-implemented method of claim 1, wherein the statistical advantage is declared for the first template when the selected win threshold, the precision threshold, and the volume threshold are all met.

4. The computer-implemented method of claim 1, wherein the generating of the estimates, determining the precision, and determining the volume threshold, are performed simultaneously.

5. The computer-implemented method of claim 1, wherein the analysis method includes generating a win probability, wherein the win probability represents a probability that a template variation currently leading the testing has a higher success rate than other variations after accounting for random chance.

6. The computer-implemented method of claim 5, further comprising determining that a conversion rate is similar to conversion rates of forms, as opposed to other parts of the website.

7. The computer-implemented method of claim 1, wherein determining that the precision of the estimates of the success rate is greater than a precision threshold comprises:
comparing a fraction of credible intervals that are overlapping, wherein credible intervals include a range of values that the success rate is likely to fall within after accounting for random chance.

8. The computer-implemented method of claim 1, wherein assigning a respective group of the site visitors to the first template of the form and the second template of the form, wherein the assigning is random, comprises:
applying an adaptive method to set an allocation of site visitors to templates that are performing better;
randomly assigning the site visitors to the first template and the second template based on the allocation; and
displaying the first template or the second template to the site visitors as randomly assigned.

9. The computer-implemented method of claim 8, wherein the assignment of each of the site visitors is included within information attached to a browser of the site visitor, wherein the information allows actions by the site visitor to be tracked.

10. The computer-implemented method of claim 9, further comprising:
determining a site visitor is eligible for the form based on whether the information attached to the browser of the site visitor indicates the site visitor has been assigned to the first template of the form and the second template of the form;
maintaining the assignment of the site visitor based on the information attached to the browser of the site visitor.

11. The computer-implemented method of claim 1, further comprising integrating information received from the testing with electronic marketing information.

12. The computer-implemented method of claim 11, wherein the electronic marketing information includes one or more of site visitor actions, discount offers, and product purchases.

13. The computer-implemented method of claim 11, wherein integrating information received from the testing with electronic marketing information comprises using electronic marketing information to qualify the site visitors for the testing, includes ensuring that site visitors in the testing have all taken actions pertaining to other marketing actions.

14. The computer-implemented method of claim 11, wherein integrating information received from the testing with electronic marketing information comprises dynamically updating content in the templates based on actions or characteristics of the user within the electronic marketing information.

15. The computer-implemented method of claim 11, wherein integrating information received from the testing with electronic marketing information includes at least some of the test information determined during testing of the templates being used for influencing marketing information.

16. The computer-implemented method of claim 1, wherein the different content of the first template and the second template includes at least visual representations of the form, including at least one of a size, a text, a layout, a design, colors, or images of the form.

17. The computer-implemented method of claim 1, wherein the different behavior of the first template and the second template includes at least a time or scroll delay before the form appears, an exit intent or lack thereof, a portion of a screen that the form appears on, or an appearance method.

18. A system for automated testing and selection of multiple templates of a form, comprising:
a site manager operating to manage a website;
a plurality of site visitors operating to visit the website;
a server electronically connected to the site manager, the plurality of site visitors, and the website, the server operating to:
generate at least a first template of the form and a second template of the form, each of the first template and the second template having at least a different content or a different behavior;
assign a respective group of site visitors to the first template of the form and the second template of the form, wherein the assigning is random;
determine automatically whether the first template of the form has a statistical advantage over the second template of the form through testing, comprising the server operating to:
collect test data from testing including qualification for views, views, and successes of the first template of the form and the second template of the form;
generate estimates of a success rates for the first template and the second template including applying an analysis method to the collected test data to determine a win probability difference between a win probability for the first template and a win probability for the second template, and determine that the win probability difference is greater than a selected win threshold;
determine that a precision of the estimates of the success rate is greater than a precision threshold;
determine that greater than a volume threshold of test data has been collected;
display the form of the first template on the website when the first template of the form is determined to have the statistical advantage over the second template of the form.

19. The system of claim 18, wherein the analysis method includes generating a win probability, wherein the win probability represents a probability that a template variation currently leading the testing has a higher success rate than other variations after accounting for random chance.

20. The system of claim 18, wherein determining that the precision of the estimates of the success rate is greater than a precision threshold comprises:
comparing a fraction of credible intervals that are overlapping, wherein credible intervals include a range of values that the success rate is likely to fall within after accounting for random chance.
